(19) United States
(12) Patent Application Publication
(10) Pub. No.: US 2024/0289504 A1
(43) Pub. Date: Aug. 29, 2024

(54) METHOD OF MODIFYING A SPACE-FILLING LATTICE USING A BOUNDARY-REPRESENTATION MODEL

(71) Applicant: Siemens Industry Software Inc., Plano, TX (US)

(72) Inventors: Simon Butler, Cambridge (GB); Rhona Maclean, Cambridge (GB); Richard Collins, Cambridge (GB); Peter Nanson, Cambridge (GB)

(21) Appl. No.: 18/681,765

(22) PCT Filed: Aug. 31, 2021
(86) PCT No.: PCT/US2021/048371

§ 371 Date: Feb. 6, 2024

(51) Int. Cl. G06F 30/10; G06F 113/10

(52) U.S. Cl. CPC G06F 30/10; G06F 2113/10

(57) ABSTRACT

A computer-implemented method of determining the dimensions of a space-filling lattice in a solid model is disclosed, wherein information including a lattice, a set of faces, and data indicating a spatial relationship between the lattice and each face in the set is received. A set of points indicating the intersection positions where each rod intersects a face is identified, and each intersecting rod is classified based upon whether or not each subset of mutually tolerantly coincident points within the set indicates that a rod is divided by a face. If a rod is divided, the lattice is modified by adding a new ball where the rod is divided and classifying the new rods either side of it. These classifications are spread to adjacent rods without crossing any new ball to establish the complete set of surviving rods. Each connected set of surviving rods is used to instantiate a new lattice.

The present patent document is a § 371 nationalization of PCT Application Serial No. PCT/US2021/048371, filed Aug. 31, 2021, designating the United States, which is incorporated by reference in its entirety.

### TECHNICAL FIELD

The present disclosure relates to a computer-implemented method of modifying of a space-filling lattice using a boundary-representation model, in particular, wherein the lattice lies within a region enclosed by a plurality of connected sets of faces each including a portion of a two-dimensional surface, and wherein the lattice includes a plurality of linked linear rods and balls.

### BACKGROUND

Computer-Aided Design (CAD) systems are used commonly in many fields of engineering, manufacturing, and design to create and manipulate solid modelling representations of objects, for example, in additive manufacturing. Boundary representation (B-rep) technology dominates CAD modelling. The B-rep technology provides an efficient and adaptable representation of parts by combining classic geometry: analytic surfaces and curves, non-uniform rational basis spline (NURBS) and procedural surfaces and curves; with topology, which captures the connectivity and interaction between geometric elements. Additive manufacturing is the process of creating three-dimensional objects using a three-dimensional printer based on CAD or other digital three-dimensional models. Objects may be scanned as a precursor to creating a CAD model, or may be designed from scratch, and stored in either STL (stereolithography file format) or AMF (additive manufacturing file format) files for future printing. Lattices are a common type of interior space-filler used in additive manufacturing as their lightweight, yet rigid construction makes them ideal for this purpose—the object is strengthened but its mass density remains relatively low. In B-rep (Boundary Representation) modelling, such spaces are enclosed by closed, connected sets of faces, where each face is a portion of a two-dimensional surface. The faces have boundary edges, which are defined by curves where the faces intersect with one another.

One example of an irregular lattice is a set of linear rods connected to each other by spherical balls. The ball radii may be constant across the lattice or vary across the entire lattice. Similarly, the rods may vary in thickness along their length. However, both rods and balls may only exist within the lattice in their entirety, meaning that a lattice cannot contain a portion of a ball, and that all rods are terminated by balls. For lattices to represent the geometry of a region, they may be “clipped.” This is to provide that the lattice skeleton does not exceed the boundary of the region in which the lattice is situated, and because the region is bounded by connected sets of faces, the rods, and/or centers of the balls of the lattice cannot penetrate the surface of the faces, nor may partial rods or balls be used instead. The latter is a risk if a lattice is later instantiated as a mesh surface and operated upon with conventional solid modelling Boolean operations.

One method in which space-filling lattices are generated is to use Boolean operations on a wire body equivalent to the skeleton of the lattice. Once operated on, the resulting wire body may be used to construct a new lattice. The method is limited due to the underlying functionality being unaware of the constraints of lattice geometry and not all Boolean operations, (e.g., the intersection between a wire body and a solid object), being supported. When working with a lattice analogue, the Boolean operations may not take into account issues such as whether a wire representing a rod is long enough to be retained in the resulting clipped lattice or whether it is in fact a fragment, (for example, an isolated single-rod lattice formed from a rod that has been clipped multiple times) and may be discarded. In addition, such algorithms may not be designed with the complexities of a lattice in mind. These include the large number of edges and vertices representing the rods and balls and the level of connectivity (e.g., many closed loops). This may negatively affect the efficiency of the algorithm, particularly when trying to identify a set of interacting rods. The memory consumption of such wire body analogues may also be high because the representation stores a separate geometry for each edge, and it is unable to assume that each edge is a straight line between its two vertices. Clipping a lattice therefore requires an accurate representation of the lattice itself as well as an understanding of how its dimensions are determined by its environment. It would therefore be very desirable to be able to clip a lattice in the modelling of additive manufactured objects without the inherent drawbacks of using analogue representations.

### SUMMARY

The scope of the present disclosure is defined solely by the appended claims and is not affected to any degree by the statements within this summary. The present embodiments may obviate one or more of the drawbacks or limitations in the related art.

The present disclosure aims to address these issues by providing a computer-implemented method of modifying a space-filling lattice in a solid model such that the lattice lies entirely within a region defined by a plurality of connected sets of faces each including a portion of a two-dimensional surface, and wherein the lattice includes a plurality of linked linear rods and balls. The method includes: receiving input information including a lattice, a set of faces, and data indicating a spatial relationship between the lattice and each face in the set; identifying, using the input information for each rod, a set of unique points indicating the intersection positions where the rod intersects a face; arcing a rod or a ball based upon whether or not the set indicates that a rod is divided by a face and storing a classification based upon the marking; if a rod is divided, modifying the lattice by deleting the divided rod and adding a new ball and new rods connecting the new ball to the balls of the divided rod; marking any new rods and balls based upon whether or not the set indicates that a rod is divided by a face and storing a classification based upon the marking; and iteratively spreading the classification of all rods identified as surviving to all of their neighbors without crossing a marked ball, such that the complete set of surviving rods is identified; and creating a new lattice from each connected set of surviving rods so identified.

By determining the dimensions of a lattice without the need to use an analogous representation, such as a wire body, the lattice is entirely bounded by the set of faces and therefore clipped. This enables the use of an efficient volume structure for additive manufacturing at lower computing cost when compared with analogous methods.

The data indicating a spatial relationship between the lattice and each face in the set may include a set of flags specifying whether lattice material is deleted if it lies in front of or behind a face. The identifying includes building a hierarchical spatial directory for the rods in the lattice, building a hierarchical spatial directory for the faces bounding the region, and clashing the directories to identify the maximal number of rods that intersect any of the faces. The identifying may further include defining a straight line for each rod that runs from its low-index ball to its high-index ball and intersecting it with each clashing face of that rod to identify the set of points at which a rod intersects a face. If adjacent points in the set lie on a common edge or vertex of a face, the convexity of the edges may be evaluated to determine whether the intersection is on the front side or back side of both faces.

The iterating may be carried out in index order.

The marking may include using the set of flags, if provided, to indicate whether a segment of a rod on either side of a set of points survives, does not survive, or is a coincident region, and wherein the classifying includes using the indication as the classification.

The boundaries of the face, (e.g., edges and vertices), may be associated with a position tolerance.

If a point in a set is tolerantly within the range of a position of a ball, both the rod and the ball may be marked, and if a point in a set is outside the range of a position of a ball, only the rod may be marked.

The iteration may be completed when all of the rods that are connected and classified as surviving are identified.

The modifying may further include determining if the set is interior to the rod and the classifications are opposed, such that on one side of the set the rod survives but on the other side of the set the rod does not survive. If this condition is satisfied, the method may include modifying the lattice.

The present disclosure also provides, in a second aspect, a computer program containing instructions which when executed by a computer cause the computer to carry out the method outlined above.

### BRIEF DESCRIPTION OF THE DRAWINGS

The present disclosure will now be described by way of example only, and with reference to the accompanying drawings, in which:

FIG. 1 illustrates an example of a data processing system in which embodiments may be implemented.

FIG. 2 is a schematic two-dimensional illustration of a portion of a lattice, according to an embodiment.

FIG. 3 is a flow chart illustrating a method of determining the dimensions of a space-filling lattice in a solid model in accordance with embodiments.

FIG. 4a is a schematic illustration of the intersection of two faces with a rod, according to an embodiment.

FIGS. 4b (i), (ii), and (iii) depict a schematic representation of the relationship of the rod and face intersection, according to an embodiment.

FIG. 4c is a schematic representation of a modified lattice in accordance with the embodiments.

FIG. 5 is a schematic representation of a two-dimensional illustration of a lattice portion crossed by a pair of faces, according to an embodiment.

FIG. 6a illustrates a view of the lattice portion of FIG. 5 where rod portions positioned in front of the faces in the direction of the surface normal are retained, according to an embodiment.

FIG. 6b illustrates a view of the lattice portion of FIG. 5 where rod portions positioned behind of the faces in the direction opposite the surface normal are retained, according to an embodiment.

FIGS. 7a to 7c are a schematic representation of a two-dimensional illustration of a lattice portion crossed by a single face at various stages in the method of the embodiments.

FIG. 8 is a schematic two-dimensional illustration of a portion of a lattice illustrating a coincidence of a face and a rod, according to an embodiment.

FIG. 9 is a schematic two-dimensional illustration of a portion of a lattice illustrating a tangency between a spherical surface and a rod, according to an embodiment.

FIG. 10 is a schematic two-dimensional illustration of a portion of a lattice illustrating multiple faces meeting at a point and clashing with a rod, according to an embodiment.

FIG. 11 is a schematic two-dimensional illustration of a portion of a lattice illustrating multiple faces meeting tolerantly at a point and clashing with a rod, according to an embodiment.

### DETAILED DESCRIPTION

Rather than use an analogue representation of a lattice to generate a clipped lattice, using the lattice itself in conjunction with b-rep modelling operations in accordance with the methods of the embodiments below results in a space-filling lattice with accurate dimensions that is completely bounded by its surrounding faces. The lattice lies within a region defined by a plurality of connected sets of faces, each of which includes a portion of a two-dimensional surface. The lattice itself includes a plurality of linked linear rods and balls as described above and described in more detail below. Initially, input information is received, which includes a lattice, a set of faces and data indicating a spatial relationship between the lattice and each face in the set. It is then necessary to identify, using the input information for each rod, a set of points indicating the intersection positions where the rod intersects one or more faces. These points have tolerances associated with them that are determined either by the modeler precision or the tolerance of any edge or vertex at which an intersection occurs. The set of points on a given rod is thus grouped into subsets of mutually coincident points wherever they lie within tolerance of one another. Next, a rod or a ball is marked based upon whether or not the subset indicates that a rod is divided by a face. A classification based upon this marking is then stored. If a rod is divided, the lattice is modified by deleting the divided rod and adding a new ball and new rods connecting the new ball to the balls of the divided rod. Again, any new rods and balls are marked based upon whether or not the subset indicates that a rod is divided by a face and the classification is stored. The classification of all rods identified as surviving to all of their neighbors without crossing a marked ball is then spread iteratively, such that the complete set of surviving rods is identified. Finally, a new lattice is created from each connected set of surviving rods so identified.

Rather than concentrating on the volume geometry of the lattice structure, the methods of the embodiments below are concerned only with the connectivity within the lattice between the rods and the balls.

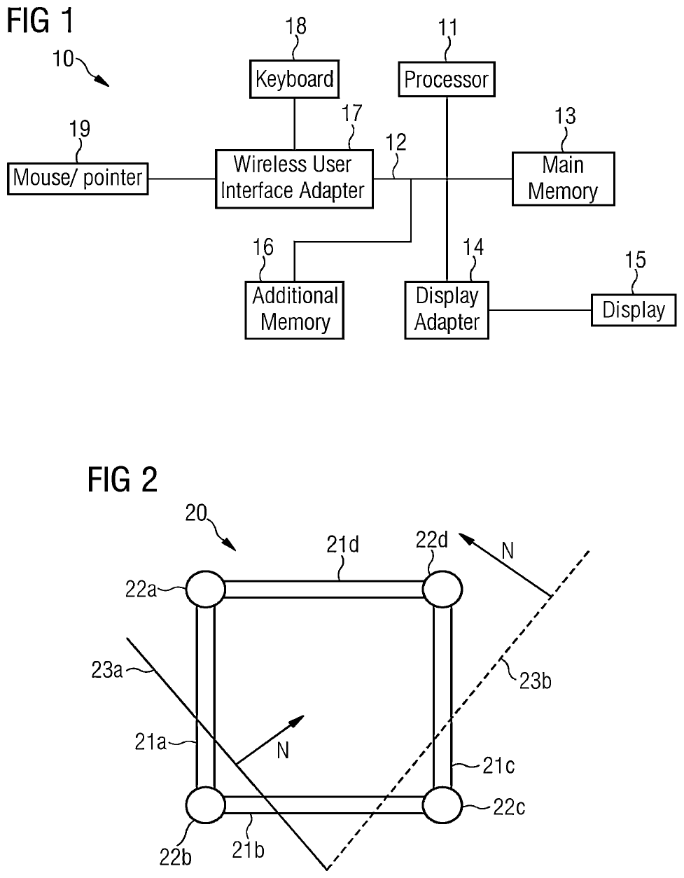

FIG. 1 illustrates an example of a data processing system in which an embodiment of the present disclosure may be implemented, for example, a CAD system configured to perform processes as described herein. The data processing system 10 includes a processor 11 connected to a local system bus 12. The local system bus connects the processor to a main memory 13 and graphics display adaptor 14, which may be connected to a display 15. The data processing system may communicate with other systems via a wireless user interface adapter connected to the local system bus 12, or via a wired network, e.g., to a local area network. Additional memory 16 may also be connected via the local system bus. A suitable adaptor, such as wireless user interface adapter 17, for other peripheral devices, such as a keyboard 18 and mouse 19, or other pointing device, allows the user to provide input to the data processing system. Other peripheral devices may include one or more I/O controllers such as USB controllers, Bluetooth controllers, and/or dedicated audio controllers (e.g., connected to speakers and/or microphones). Various peripherals may be connected to the USB controller (e.g., via various USB ports) including input devices (e.g., keyboard, mouse, touch screen, trackball, camera, microphone, scanners), output devices (e.g., printers, speakers), or any other type of device that is operative to provide inputs or receive outputs from the data processing system. Further, many devices referred to as input devices or output devices may both provide inputs and receive outputs of communications with the data processing system. Further, other peripheral hardware connected to the I/O controllers may include any type of device, machine, or component that is configured to communicate with a data processing system.

An operating system included in the data processing system enables an output from the system to be displayed to the user on display 15 and the user to interact with the system. Examples of operating systems that may be used in a data processing system may include Microsoft Windows™, Linux™, UNIX™, iOS™, and Android™ operating systems.

In addition, data processing system 10 may be implemented as in a networked environment, distributed system environment, virtual machines in a virtual machine architecture, and/or cloud environment. For example, the processor 11 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system 10 may vary for particular implementations. For example, the data processing system 10 in this example may correspond to a computer, workstation, and/or a server. However, alternative embodiments of a data processing system may be configured with corresponding or alternative components such as in the form of a mobile phone, tablet, controller board, or any other system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

The data processing system 10 may be connected to the network (not a part of data processing system 10), which may be any public or private data processing system network or combination of networks, as known to those of skill in the art, including the Internet. Data processing system 10 may communicate over the network with one or more other data processing systems such as a server (also not part of the data processing system 10). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

FIG. 2 is a schematic two-dimensional illustration of a portion of a lattice. The lattice 20 includes a plurality of linked linear rods 21a, 21b, 21c, 21d and spherical balls 22a, 22b, 22c, 22d, which act to connect the linear rods 21a, 21b, 21c, 21d together. A first face 23a intersects two of the rods 21a, 21b, passing out through the second rod 21b to a vertex 24. A second face 23b, joined to the first face 23 at the vertex 24 passes back through the second rod 21b and intersects a third rod 21c. The normal N to the second face 23b is also indicated.

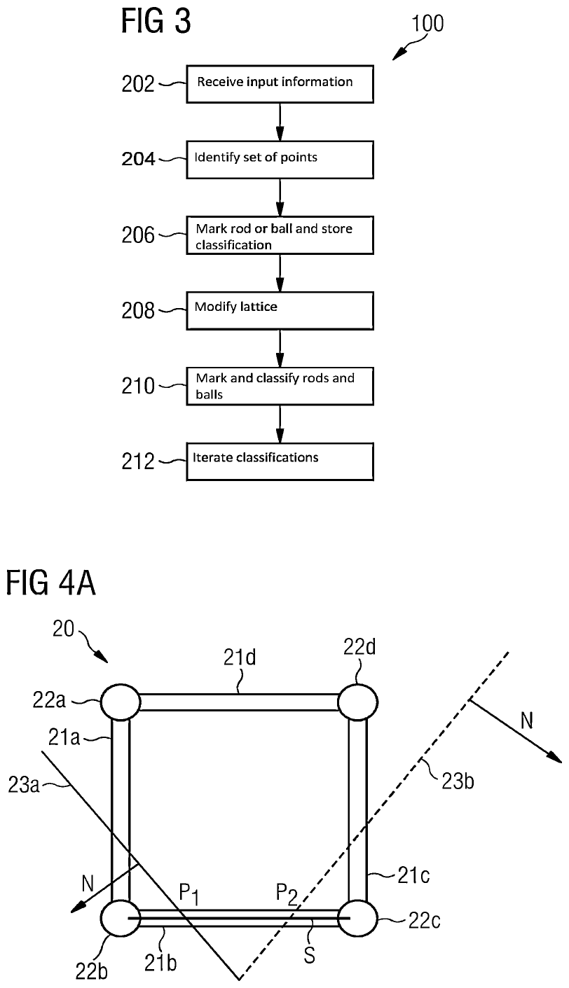

FIG. 3 is a flow chart illustrating a method of determining the dimensions of a space-filling lattice in a solid model in accordance with embodiments. The method 200 is carried out on a data system, such as that illustrated in FIG. 1, by a computer program that contains instructions that when executed on the data processing system 1 causes it to carry out the acts of the method 200. The process of clipping effectively trims the lattice to be bounded by the set of faces, providing that the lattice does not exceed the supplied boundary and provides a fully workable structure for additive manufacturing.

Initially, at act 202, the data system receives input information including a lattice 20, a set of faces 23a . . . 23n and data indicating a spatial relationship between the lattice 20 and each face 23a . . . 23n in the set. The set of faces 23a . . . 23n is provided from one or more B-rep bodies. The data indicating a spatial relationship between the lattice and each face in the set includes a set of flags specifying whether lattice material is deleted if it lies in front of or behind a face. For example, looking at FIG. 2, the second face 23b would be provided with a flag to indicate that any lattice material on its external side (that facing away from the direction of the face normal N) is deleted.

At act 204, using the input information for each rod 21a . . . 21n, a set of points indicating the intersection positions where the rod 21a . . . 21n intersects a face 23a, 23b is identified. This is done by building a hierarchical spatial directory for the rods 21a . . . 21n in the lattice 20, building a hierarchical spatial directory for the faces 23a, 23b defining the region in which the lattice 20 sits and clashing the directories to identify the maximal number of rods 21a . . . 21n that intersect any of the faces 23a, 23b. The spatial directory is a box tree structure (bounding volume hierarchy), and by clashing a box tree for both the rods 21a . . . 21n in the lattice 20, the maximal set of rods 21a . . . 21n that may intersect with any of the faces 23a, 23b, is identified. The balls at the end of each rod are numbered consecutively to provide a low index ball and a high index ball. Each rod 21a . . . 21n is considered to be positive sense such that it points from its low-index ball to its high-index ball. A straight-line S is extended from the low index ball 22b of a rod 21b to the high index ball 22c of a rod 21b, which then intersects the first face 23a. If more than one face crosses a rod 21a then the straight-line S will intersect more than one face, allowing the identification of a set of points at which rod 21b intersects a face. Each rod 21a . . . 2n may cross, touch or be coincident with a face.

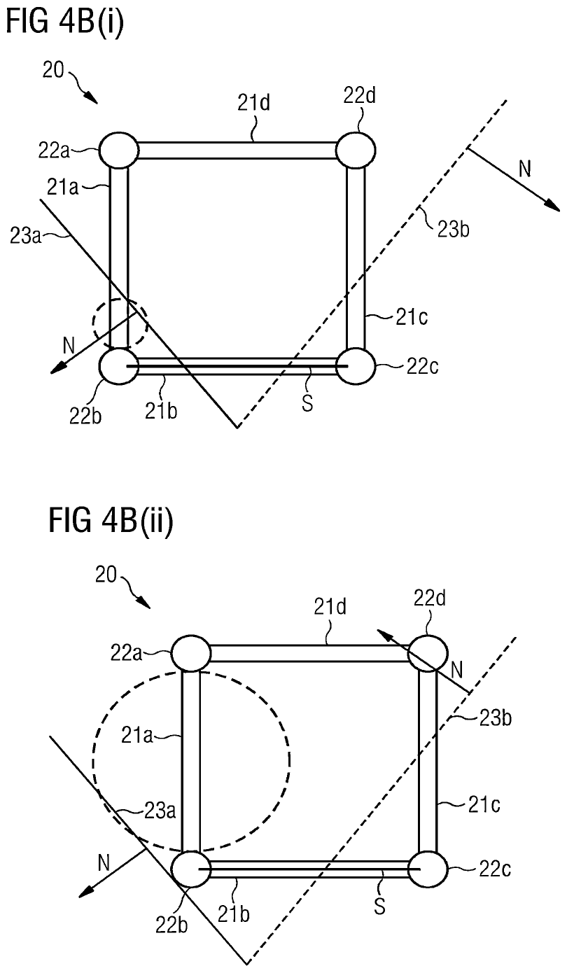

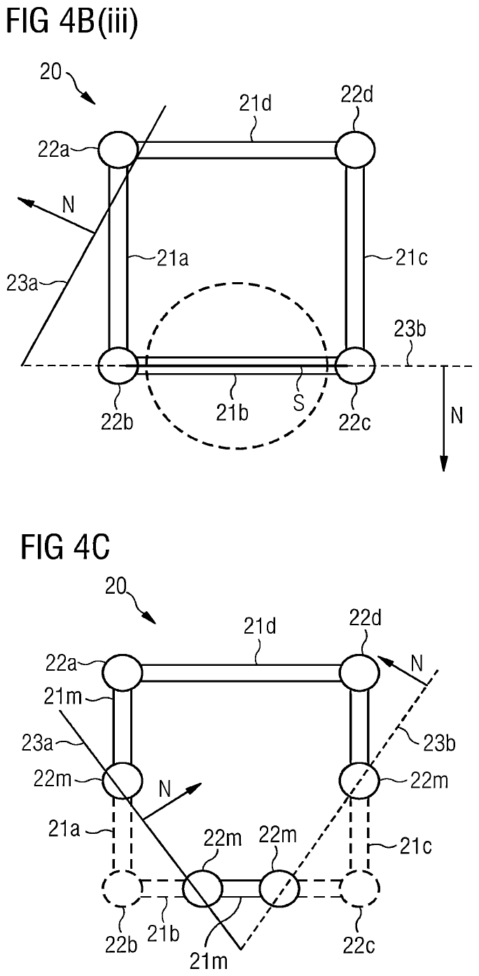

The entire line S, subsections of the line S, points on the line S or a combination thereof may therefore intersect the surface of face 23. The lines or points are then tested against the face boundaries to determine which lie within the face 23 rather than merely in the surface of the face 23. This is highlighted in FIG. 4a, which is a schematic illustration of the intersection of two faces 23a, 23b with a rod 21b. A line Sis drawn between the low index ball 22b and the high index ball 22c of the rod 21b, passing through the first face 23a. A first point P₁ indicates where the line crosses the face 23a. The line S also passes through the second face 23b, which is indicated by a second point P₂. There are consequently two points at each intersection, as the rod 21b is touching a face 23a, 23b on both sides of the intersection. Each rod 21a . . . 21n is therefore associated with a set of points that is the total set of positions at which any face crosses it, touches it or becomes coincident with it. The boundary topologies of the faces 23a, 23b (e.g., the edges and vertices) may have position tolerances associated with them. These are effectively tubes or spheres surrounding those boundary topologies with radii greater than the precision of the computer program carrying out the modelling. Therefore, each point in a set will also have a tolerance associated with it if it occurs within a tolerance tube or sphere. Consequently, the set of points associated with any rod 21a . . . 21n is organized into subsets identifying the different intersection positions on the rod 21a . . . 21n that are distinct from those in any other subset, including for the same rod 21a . . . 21n.

At act 206, a rod or a ball is marked based upon whether or not the subset indicates that a rod is divided by a face, and a classification based upon this marking is stored. The subsets are examined in order from that closest to the low-index ball 22a of the rod 21b up to that closest to the high-index ball 22b of the rod 21b. For each subset, the interaction for each point in the subset is examined to determine whether it indicates that the rod 21b is divided. Two or more points may have opposite interactions associated with them, such as if one indicates a switch from the back to the front of the face and the other indicates a switch from the front to the back of the face. This is then compared with the relevant set of flags for the face provided in the input information in act 202. If the relevant set of flags for the faces are opposed, then this is not an issue. However, if the relevant set of flags for the faces are not opposed, then this is a conflict to be resolved. If these adjacent points in the subset lie on a common edge or vertex of a face 23a, 23b, the convexity of the edges is evaluated to determine whether the intersection is on the front side or back side of both faces 23a, 23b.

Once any conflicts are resolved, each point in the subset is examined to determine if and how it divides the rod 21b. Again, the set of flags included with the input information in act 202 is used, this time to mark and classify the rods 21a . . . 21n and balls 22a . . . 22n. Using the flags for the corresponding faces 23a, 23b, the segments of rod 21b that fall on either side of the subset are indicated as surviving (e.g., where the rod/ball lies inside the clipping faces), not surviving (e.g., where the rod/ball lies outside of the clipping faces), or being a coincident region (e.g., where a rod 21a . . . 21n or ball 22a . . . 22n is coincident with a face 23a, 23b). The classifications are illustrated further in FIGS. 4b(i), (ii), and (iii), which depict a schematic representation of the relationship of the rod and face intersection. Like reference numbers with FIG. 4a are omitted for clarity. For a face 23a having a normal N crossing a rod 21a, there is a portion of the rod 21a outside of the subset of points that lies beyond the face 23a, circled in FIG. 4b(i), which does not survive. For a face 23a that touches a rod 21a, the entire rod 21a lies within the boundary of the region formed by the face 23a, therefore the rod 21a survives, circled in FIG. 4b(ii). FIG. 4b (iii) shows face 23b is coincident with a rod 21b, where the rod is not assigned an immediate survival classification, as it will inherit it from its neighbors later in the process instead. The indication is used to mark the rods 21a . . . 21n and balls 22a . . . 22n and stored as a classification. If a subset of points is within the range of a position tolerance of a ball, both the rod 21a and the ball 22a are marked, and if a subset is outside the range of a position tolerance of a ball, only the rod 21a is marked.

If all of the points in a subset agree, a determination needs to be made whether or not to modify the lattice 20. In addition to the marking of the rods 21a . . . 21n and balls 22a . . . 22n, if the subset is interior to the rod 21a (in other words, not within the tolerance of an end of the rod 21a), and the classifications are opposed, such that on one side of the subset the rod 21a survives but on the other side of the subset the rod 21a does not survive, the lattice 20 is modified.

At act 208, if a rod is divided, the lattice 20 is modified by deleting the divided rod 21a and adding a new ball 22m and new rods 21m and 21n connecting the new ball 22m to the balls 22a and 22b of the divided rod 21a.

At act 210, each of the rods 21m and 21n and balls 22m is also marked and classified. Once all of the interaction points have been examined, there is likely to be a resulting lattice 20 in which some rods 21a . . . 21n and some balls 22a . . . 22n are marked.

At act 212, the classifications of all of the marked rods and balls are iterated over to establish which of them lie of the surviving side of the supplied faces. This is done, as far as possible, in index order, and includes those rods 21a . . . 21n and balls 22a . . . 22n marked and classified in act 210. The procedure begins by selecting the lowest-index rod that has been classified as surviving. Each ball of the rod is then examined to identify if it was marked in act 210. If it was marked, the balls of all other surviving or coincident rods of that ball are added to the queue for processing. If it is unmarked, all balls of other rods connected to that ball are added to the queue. If a rod of an unmarked ball reached via this process is classified as being deleted, the operation fails. This process repeats for all other balls in the queue until everyone that may be reached without crossing a marked ball has been processed. Similarly, once the full queue of balls has been processed, the next-lowest-index rod marked as survive that has not yet been visited by the above process is chosen as the next starting point and the process is repeated. The iteration is completed when all of the rods 21n that are connected and classified as surviving are identified. Each connected set of surviving rods 21n collected in this act is used to create the new clipped lattice. If the connected set of rods 21n does not contain at least one rod 21n marked as survive, then a new lattice is not created from it. This process is illustrated in FIG. 4c, which is a schematic representation of a modified lattice in accordance with the embodiments. FIG. 4c illustrates a modified lattice 20 based on FIG. 2, where a first face 23a and a second face 23b each intersect with three rods 21a, 21b, 21c. The original positions of the rods 21a, 21b, 21c and balls 22b22c are marked in broken lines. In this example all three rods 21a, 21b, 21c having an intersection with a face 23a, 23b do not survive, and are replaced by four balls 22m and three rods 21m clipped within the faces 23a, 23b.

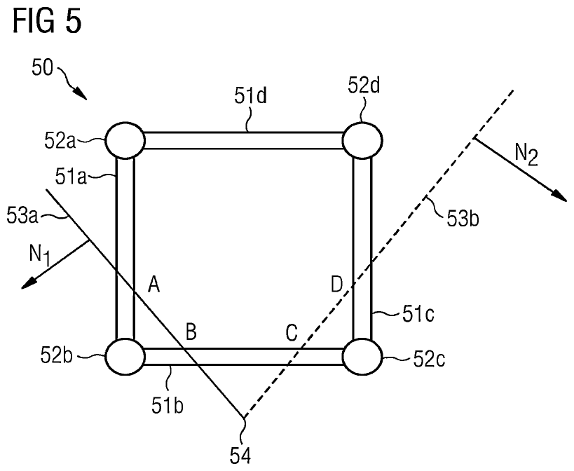

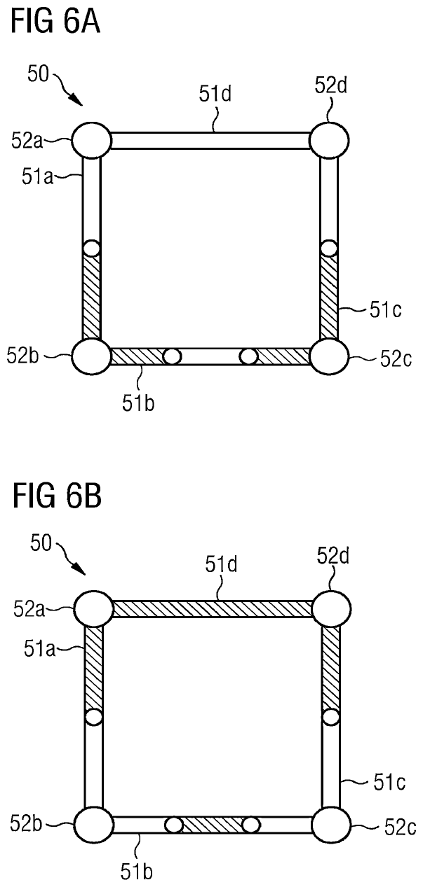

The following figures illustrate the various stages of the methods of the embodiments in more detail. FIG. 5 is a schematic representation of a two-dimensional illustration of a lattice portion crossed by a pair of faces. The lattice portion 50 includes four rods 51a, 51b, 51c, 51d linked together by four balls 52a, 52b, 52c, 52d in the shape of a square as a representation of a lattice portion 50. A first face 53a, having a surface normal N₁, crosses a first rod 51a and a second rod 51b, and a second face 53b, having a surface normal N₂, crosses the second rod 51b and a third rod 51c, and meets the first face 53a at a vertex 54. FIG. 6a illustrates a view of the lattice portion of FIG. 5 where rod portions positioned in front of the faces in the direction of the surface normal are retained. The crossing points of the first 53a and second 53b faces on each of the first 51a, second 51b and third 51c rods are marked: A is where the first face 53a crosses the first rod 51a; B is where the first face 53a crosses the second rod 51b; C is where the second face 53b crosses the second rod 51b; and D is where the second face 53b crosses the third rod 51c. By examining the crossing points A, B, C, D, and the directions of the surface normals N₁, N₂, it is possible to determine whether or not a rod will survive. The portion of the first rod 51a that lies behind the first face 53a, opposite to the surface normal N₁ will not survive, and similarly, the portion of the third rod 51c that lies behind the second face 53b, opposite to the surface normal N₂ will also not survive. The portion of the second rod 51b that lies between the first face 53a and the second face 53b does not survive either, because this lies behind both faces 53a, 53b. Those rod positions that are not retained are shown as a solid color, and those that are retained are shown in outline to illustrate this point. FIG. 6b illustrates a view of the lattice portion of FIG. 5 where rod portions positioned behind of the faces in the direction opposite the surface normal are retained. This is effectively the opposite situation to that illustrated in FIG. 6a. In this example, the portions of the first rod 51a, the second rod 51b, and the third rod 51c that lie behind the first 53a and second 53b faces are retained and are therefore illustrated in a solid color.

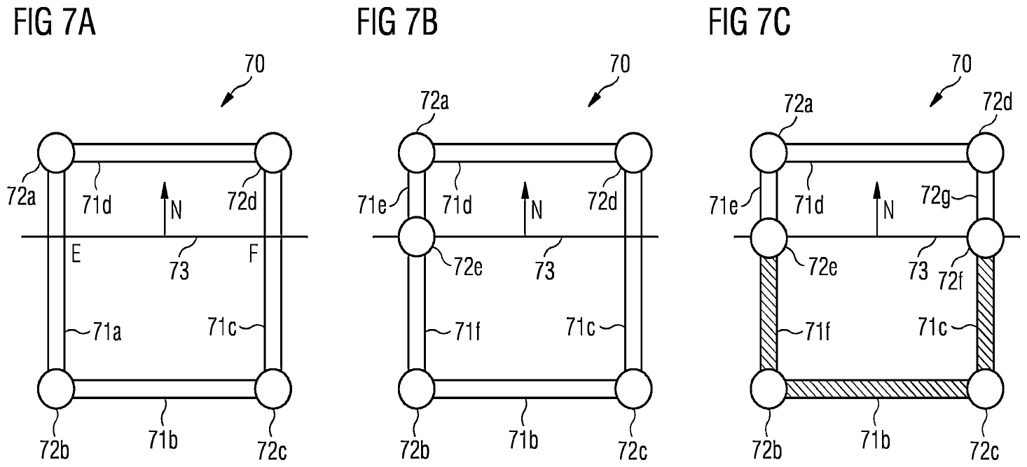

FIGS. 7a to 7c are schematic representations of a lattice portion illustrating the marking and lattice generation processes. FIG. 7a is a schematic representation of a two-dimensional illustration of a lattice portion crossed by a single face. The lattice portion 70 includes four rods 71a, 71b, 71c, 71d linked together by four balls 72a, 72b, 72c, 72d in the shape of a square as a representation of a lattice portion 70. A face 73, having a surface normal N₁, crosses a first rod 71a and a third rod 71c, at crossing points E and F. The face 73 crosses the first rod 71a and the third rod 71c approximately halfway between the first 72a and second 72b balls, and the third 72c and fourth 72d balls, respectively. In this example, everything positioned below the surface 73 (opposite to the direction of the surface normal N) is to be discarded. At this point, it is possible therefore to determine the clashes between the rods and face (e.g., the first rod 71a and the third rod 73c) and to begin the process of iteratively spreading the classification of the rods and balls.

In FIG. 7b, the first rod 71a is removed, as this clashes with the face 73, and a fifth ball 72e is added, and marked. Fifth 71e and sixth 71f rods are added between the fifth ball 72e and the first ball 72a, and the fifth ball 72e and the second ball 72b, respectively. The fifth 71e and sixth 71f rods are also marked.

In FIG. 7c, this process is repeated for the clash with the third rod 71c, adding a sixth ball 72f and seventh 71g and eighth 71h rods between the sixth ball 72f and the fourth ball 72d and the sixth ball 72f and the third ball 72c, respectively. The sixth ball 72f and the seventh 71g and eight 71h rods are also marked, resulting in two marked balls 72e, 72f and four marked rods 71e, 71f, 71g, 71h. It is now also possible to indicate that two of these marked rods, the fifth 71e and seventh 71g rods will be retained as they lie above the face 73 (and are therefore shown in outline) and the sixth 71f and eighth 71h rods will be discarded as they lie below the face 73 (and are therefore shown in solid color).

The spreading process begins by starting from the first marked rod, which is the fifth rod 71e, the first ball 72a and the fifth ball 72e are placed in a queue for examination. The fifth ball 72e is marked, so the spreading process does not cross the marked ball 72e, but the first ball 71a is not, hence it is possible to determine that the final lattice will contain the fifth rod 71e. Next, the fourth ball 72d is added to the queue, as this is next in order following the first ball 71a of the balls laying above the face 73. Because the fourth ball 72d is not marked, the classification of the fifth rod 72e is spread to the fourth rod 71d, which is then retained in the lattice. From the fourth ball 72d, the sixth ball 72f is added to the queue, as it has already been determined that the fourth rod 71d remains in the lattice and therefore only the seventh rod 72f needs to be examined. It is not possible to cross the sixth ball 72f, because this is marked, therefore only the seventh rod 71g remains in the lattice and the eighth rod 71h is not considered.

At this point, the spreading process is complete, as the classification of the fifth rod 71e has been spread to all of the rods that were laying above the surface 73. The sixth 71f, second 71b, and eighth 71h rods are discarded, along with the second 72b and third 72c balls from the original lattice portion 50. All that remains are the fifth 71e, fourth 71d, and seventh 71g rods, along with the fifth 72e, first 72a, fourth 72d, and sixth 72f balls.

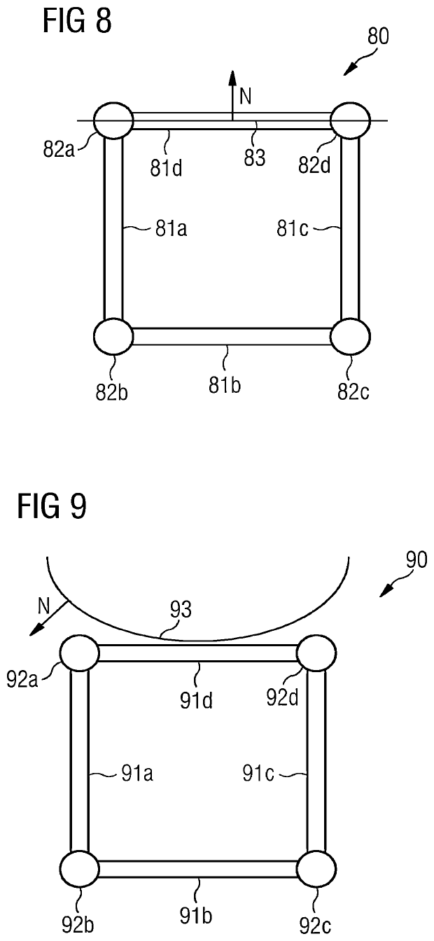

FIG. 8 is a schematic two-dimensional illustration of a portion of a lattice illustrating a coincidence of a face and a rod. The lattice portion 80 includes four rods 81a, 81b, 81c, 81d linked together by four balls 82a, 82b, 82c, 82d in the shape of a square as a representation of a lattice portion 80. A face 83, having a surface normal N₁, lies coincidently with the fourth rod 81d, (for example, the fourth rod 81d lies within the surface 83). Therefore, there are clashes with the first rod 81a, the fourth rod 81d, and the third rod 81c, as the surface 83 passes through the first 82a and the fourth 82d balls that connect these rods 81a, 81d, 81c. Consequently, both the first 82a and the fourth 82d balls are marked, and the first 81a, fourth 81d, and third 81c rods are marked and therefore classified before the spreading process begins.

FIG. 9 is a schematic two-dimensional illustration of a portion of a lattice illustrating a tangency between a spherical surface and a rod. The lattice portion 90 includes four rods 91a, 91b, 91c, 91d linked together by four balls 92a, 92b, 92c, 92d in the shape of a square as a representation of a lattice portion 90. A spherical face 93, having a surface normal N₁ lies tangent to the fourth rod 91d. The spherical surface 93 clashes with the fourth rod 91d, such that it is marked, but there are no clashes with either the first 92a or fourth 92d balls connected to the fourth rod 91d, therefore neither of these balls is marked. As the rod is tangent to the surface, it does not cross it and so the rod is not split.

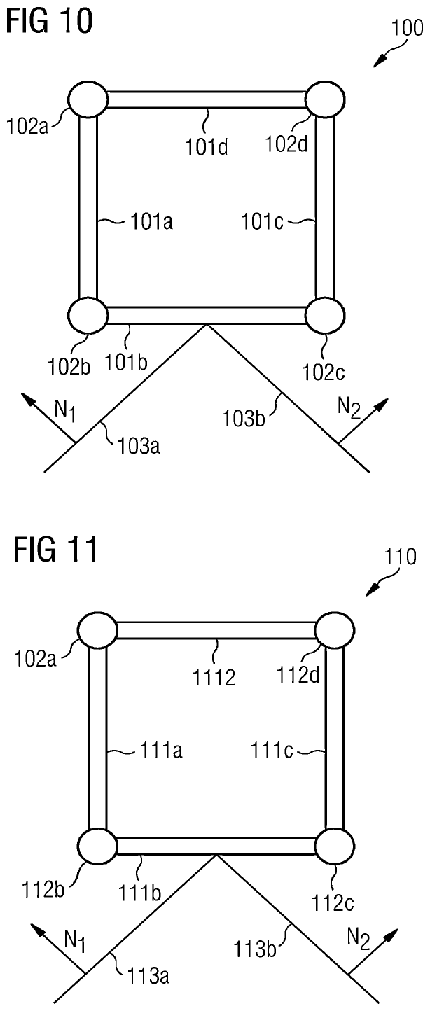

FIG. 10 is a schematic two-dimensional illustration of a portion of a lattice illustrating multiple faces meeting at a point and clashing with a rod. The lattice portion 100 includes four rods 101a, 101b, 101c, 101d linked together by four balls 102a, 102b, 102c, 102d in the shape of a square as a representation of a lattice portion 100. A first face 103a, having a surface normal N₁, meets a second face 103b, having a surface normal N₂, at an edge 104 that lies on the second rod 101b. Similarly, to the tangency example above, the only clash is with the second rod 101b because this is where the edge 104 lies. Therefore, there are no marked balls. As the rod crosses the faces 103a and 103b in opposite directions, the convexity of the edge 104 is examined in order to determine whether this is a tangent contact on the positive or negative sides of the two faces.

FIG. 11 is a schematic two-dimensional illustration of a portion of a lattice illustrating multiple faces meeting tolerantly at a point and clashing with a rod. The lattice portion 110 includes four rods 111a, 111b, 111c, 111d linked together by four balls 112a, 112b, 112c, 112d in the shape of a square as a representation of a lattice portion 110. A first face 113a, having a surface normal N₁, meets a second face 113b, having a surface normal N₂, at a tolerant edge 104 that lies on the second rod 101b. This leads to there being two contact points on the second rod 101b, one for each of the first 113a and second 113b faces. Similarly, to the example shown in FIG. 10 the only clash is with the second rod 101b because this is where the edge 104 lies. These two points are grouped together due to being within their tolerances of each other and having been produced by a common edge of the two faces. The convexity of that edge 104 is then examined as in the example above.

The use of a specific lattice geometry, rather than an analogue, such as the wire body approach used in the past, allows minimal memory consumption. Further, the use of a hierarchical box tree structure provides good performance of the algorithm at the clashing stage in act 102 to determine the intersections between rods and faces. The combination of these features results in reduced computing cost when compared with past solutions. By grouping together intersection points into tolerantly coincident sets within each rod, the same tangential contacts where multiple faces interact with the same rod may be identified and resolved. In addition, the neighbor-dependent survival of coincident region rods prevents the generation of sliver or highly anisotropic lattices at the boundary of the region as part of the clipping approach.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of modifying a space-filling lattice in a solid model such that the lattice lies entirely within a region defined by a plurality of connected sets of faces each comprising a portion of a two-dimensional surface, and wherein the lattice comprises a plurality of linked linear rods and balls, the method comprising:
receiving input information comprising the lattice, a set of faces, and data indicating a spatial relationship between the lattice and each face in the set of faces;
identifying, using the input information for each rod of the plurality of linked linear rods and balls, a set of unique points indicating intersection positions where [the] a respective rod of the plurality of linked rods and balls intersects a face of the set of faces;
grouping mutually tolerantly coincident points in the set of unique points into subsets;
marking a rod or a ball of the plurality of linked linear rods and balls based upon whether or not each subset indicates that a respective rod is divided by a face and storing a classification based upon the marking;
modifying, when the respective rod is divided, the lattice by deleting the divided rod and adding a new ball and new rods connecting the new ball to the balls of the divided rod;
marking any new rods and balls based upon whether or not each subset indicates that a rod is divided by a face and storing a classification based upon the marking;
iteratively spreading the classification of all rods identified as surviving to all neighboring rods without crossing a marked ball such that a complete set of surviving rods is identified; and
creating a new lattice from each connected set of surviving rods so identified.

2. The method of claim 1, wherein the data indicating a spatial relationship between the lattice and each face in the set comprises a set of flags specifying whether lattice material is deleted when the lattice material lies in front of a face or behind a face.

3. The method of claim 2, wherein the step of identifying comprises:
building a hierarchical spatial directory for the rods in the lattice;
building a hierarchical spatial directory for the faces bounding the region; and
clashing the directories to identify a maximal number of rods that intersect any of the faces.

4. The method of claim 3, wherein the identifying further comprises:
defining a straight line for each rod that runs from a low-index ball to a high-index ball of the respective rod; and
intersecting the straight line with each clashing face of the respective rod to identify the set of points at which a rod intersects a face.

5. The method of claim 4, wherein, when adjacent points in the set lie on a common edge or vertex of a face, a convexity of the edges is evaluated to determine whether the intersection is on a front side or a back side of both faces.

6. The method of claim 4, wherein the iteratively spreading of the classification of all rods identified as surviving is carried out in index order.

7. The method of claim 2, wherein the marking comprises using the set of flags to indicate whether a segment of a rod on either side of a set of points survives, does not survive, or is a coincident region, and
wherein the classifying comprises using the indication as the classification.

8. The method of claim 7, wherein edges and vertices forming boundaries of a face are associated with position tolerances.

9. The method of claim 8, wherein, when a mutually tolerantly coincident subset of points is tolerantly within a range of a position of a ball, both the rod and the ball are marked, and
wherein, when a subset is outside the range of a position of a ball, only the rod is marked.

10. The method of claim 1, wherein the iteratively spreading of the classification of all rods identified as surviving is completed when all of the rods that are connected and classified as surviving are identified.

11. The method of claim 1, wherein the modifying further comprises:
determining when the subset is interior to the rod and the classifications are opposed such that on one side of the subset the rod survives but on the other side of the subset the rod does not survive; and
modifying the lattice when the subset is determined to be interior to the rod and the classifications are opposed.

12. A computer program containing instructions that, when executed by a computer, cause the computer to:
receive input information comprising thae lattice, a set of faces, and data indicating a spatial relationship between the lattice and each face in the set of faces;
identify, using the input information for each rod of a plurality of linked linear rods and balls, a set of unique points indicating intersection positions where a respective rod of the plurality of linked rods and balls intersects a face of the set of faces;
group mutually tolerantly coincident points in the set of unique points into subsets;
mark a rod or a ball of the plurality of linked linear rods and balls based upon whether or not each subset indicates that a respective rod is divided by a face and storing a classification based upon the marking;
modify, when the respective rod is divided, the lattice by deleting the divided rod and adding a new ball and new rods connecting the new ball to the balls of the divided rod;
mark any new rods and balls based upon whether or not each subset indicates that a rod is divided by a face and storing a classification based upon the marking;
iteratively spread the classification of all rods identified as surviving to all neighboring rods without crossing a marked ball such that a complete set of surviving rods is identified; and
create a new lattice from each connected set of surviving rods so identified.
